(19) United States
(12) Patent Application Publication
(10) Pub. No.: US 2020/0178570 A1
(43) Pub. Date: Jun. 11, 2020

(54) METHOD FOR BORING INTO A COCONUT WITH A THREADED STOPPER INCORPORATED INTO SAME

(71) Applicant: Lisandro ESTARRÓN ESPINOSA, Villa de Alvarez (MX)

(72) Inventor: Lisandro ESTARRÓN ESPINOSA, Villa de Alvarez (MX)

(21) Appl. No.: 16/614,622

(22) PCT Filed: May 17, 2017
(86) PCT No.: PCT/IB2017/052891

§ 371 Date: Nov. 18, 2019

(51) Int. Cl. A23L 2/04; A23N 5/03; A23L 19/00; B65D 25/42; B65D 85/72; A23L 3/46

(52) U.S. Cl. CPC A23L 2/04; A23N 5/03; A23L 3/46; B65D 25/42; B65D 85/72; A23L 19/03

(57) ABSTRACT

The present invention relates to a new method for drilling the coconut with an integrated screw cap, which consists of the following stages: coconut cleaning; making a cut in the endocarp of the coconut; cleaning and sanitation of the cutting area; and, placement of the screw cap to maintain the aseptic area.

### EXPLANATION OF TECHNICAL SUMMARY

The present invention consists of a method for drilling coconut, which previously, has been husked or removed the mesocarp (dry husk), placing a plastic screw cap that allows access to fresh coconut juice in an easy, fast and practical way. The field of application of the invention is aimed at the agribusiness sector, providing added value to the fruit from the origin of the production chain.

### TECHNIQUE USED PREVIOUSLY

Coconut is a tropical fruit known worldwide and that in recent years has become very popular, This is because, Coconut is the only fruit that inside contains a juice with organoleptic properties and nutritional benefits, published and scientifically proven, this causes, that its demand continues in constant growth. In the bottled beverage industry, there are several alternatives with large shelf life and coconut juice presentations, however, due to the characteristics of their processes they lose their benefits.

On the other hand, people who like to drink fresh coconut looking for its benefits and avoiding industrialized products have the disadvantage when accessing their juice, require sharp tools, with the risk of suffering an accident or buying accessories that can hardly be sold in the same place where they buy coconut, these disadvantages often inhibit their consumption on a large scale or larger volume. Currently, there are other inventive alternatives on the market that, while seeking to facilitate drinking coconut juice directly from the fruit, have technical and safety deficiencies. The patents found in the state of the art can be classified into two groups, according to their similarities:

1. Patents CA2902013, CN204916468 and 1115606U use coconuts without mesocarp (dry husk) for their operation and polished, to which a circular laser pre-cut is made to the host and rivet a ring to later pull it and remove it to drink directly from the coconut. However, these inventions share the same technical disadvantage since in the different cases when drilling the bone and riveting inevitably there is physical contact between the drilling tool and the coconut juice, in addition to the entry of oxygen into the cotyledon, causing, If there is no proper care, contamination and leakage of coconut juice so they have to seal with silicones to avoid this technical deficiency.

2. Patents CA2844398, WO2016141431, WO2014146031, U.S. Pat. No. 8,709,519, WO201611536, US20150164130, US20150048110 use the coconut without having extracted the exocarp and the mesocarp, claiming processes for drilling with circular cutting tools, with resealable cap, valve with nozzles, etc. The common disadvantages of all these proposals are several, they require the purchase of accessories that increase the cost of the final product, some skill is required to handle the cutting accessories and the most important in all of them, there is a high risk of contamination because the consumer is unaware of the handling of coconut from its packaging, logistics and final point of sale. So when drilling the contamination is highly probable, also the proposals of all of them are for coconut “jimado” (remove mesocarp) so access to its endosperm (also known as pulp) after having consumed its juice is necessary the use of sharp tools to cut the coconut in half and consume it.

The invention that will be claimed later, manages to solve the technical deficiencies located in the state of the art, the risks of handling dangerous tools, high costs for accessories, through a device and process that allows access to the content of a coconut simple and practical way.

### SUMMARY OF THE INVENTION

The method for drilling coconut with an integrated screw cap is characterized by the simplicity with which coconut juice can be accessed by simply turning the lid, easily removing a small portion of the endosperm and drinking it, by having a screw cap incorporated, allows reseal it (recap) and save its contents for another time avoiding the contamination of coconut juice or its waste.

Once the coconut is subjected to the method that will be claimed later, it is possible to conserve all the natural nutrients of the fruit, since in the process the aseptic juice inside is not compromised. This invention arises after analyzing the limitations of the consumption of coconut and commercialization of coconut, in large cities, for this purpose the most used consumption habits for liquids and juices were investigated, all indicated that they preferred screw caps that allow easy opening.

### Technical problem

The object of the present invention seeks to solve the problem associated with the use of tools and devices with respect to known formats for obtaining coconut juice easily, without losing its nutritional properties and without using preservatives, this is achieved by drilling the endocarp (also known as bone) of the coconut and without touching the endosperm that serves as a barrier natural between the environment and coconut juice, placing an open-easy cap, which facilitates its consumption quickly and safely, surpassing the current state of the art used for the same purposes.

### Problem solution

The invention proposes to extract the exocarp and mesocarp from the coconut, polish it and then make a circular cut with a drilling tool that will only drill the endocarp by removing it, leaving a part of the endosperm exposed, once it is sanitized we integrate a screw cap using a food grade adhesive, this simple and novel invention allows us to guarantee the safety of the product, and it can be resealed when its content is not fully consumed.

### Advantageous effects of the invention

The main advantage of our invention is that it makes it possible to select coconuts, by being able to visualize internally the state of the pulp, all the fruits that could be sick or in poor condition are discarded and that it is only possible to know when they have been Open by other methods.

With this, the present invention makes it possible to ensure that the pulp and juice are in optimal conditions to be consumed.

### BRIEF DESCRIPTION OF THE FIGURES

The figures presented in the drawings section are for illustrative purposes only and are not intended in any way to make an exhaustive description of the invention.

FIG. 1 shows a coconut, which has previously been removed from the exocarp and mesocarp, a circular cut has been made on the flattest face of the endocarp (bone), leaving the endosperm (pulp) in sight.

FIG. 2 it is observed, the structure of the screw cap, which consists of two parts, a cap and a threaded crown, which are divided into three main elements: iii) the cap; ii) the crown skirt and i) the crown tab.

FIG. 3 shows the coconut, to which a circular cut has been made in the endocarp leaving the endosperm in sight, in whose cut the lower face of the skirt and the outer face of the flange of the threaded crown of The screw cap

FIG. 4 shows the coconut with the threaded crown, adhered to the circular cut, indicating the placement of the screw cap, for the proper closing of the screw cap.

FIG. 5, the final product is visualized once the screw cap is attached to the coconut, with its two main elements.

### DESCRIPTION OF THE WAY OF MAKING THE INVENTION

The novel method consists of the following stages:

1) Shelling or “uncovering” the coconut, then the endocarp (bone) is polished to remove excess fibers.

2) Select coconut between 8 and 10 months of maturity, discarding those that present depressions in the circumference or that present collapses in their structure.

3) Roughing of irregular coconut bumps in order to improve its aesthetic appearance and its functionality derived from the balance of its structure.

4) Identify the most viable face for the cut, preferably using the flattest side.

5) Position the coconut with the selected face facing the cutting tool, which will preferably be placed on an axis perpendicular to said face and centered with the circumference of the coconut.

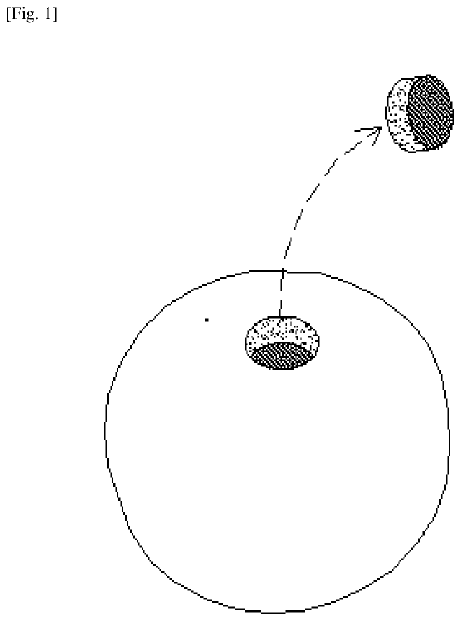

6) Making the circular cut sufficiently deep, using a specialized cutting tool within a certain variety, until reaching the endosperm (pulp) at a speed of 1,600 rpm and a pressure of 800 N/mm², (the result is observed in FIG. 1).

7) At the time of starting the cut, ozone gas (O3) is injected with two objectives: a) generate a current that raises the micro-particles resulting from the cutting stage; and b) keep the cutting tool sanitized.

8) At the moment of starting the cut, simultaneously to the two previous steps, an aspiration of the micro particles resulting from the cutting stage is carried out, which avoids: a) their accumulation in the cutting stage, whether seated on the surface of both the coconut and the station where the process is implemented; b) air circulation of the area surrounding the workstation; and c) the cross contamination of possible spores housed in the pores of the endocarp, which would otherwise contaminate the freshly drilled coconut, the workstation and the other coconuts that are undergoing the present process or that are stored nearby.

9) The cutting tool is removed, which removes the cut portion of the endocarp leaving the endosperm (pulp) exposed (the result is shown in FIG. 1).

10) Application of a gel with rapid spray drying bactericidal properties on the exposed surface of the endosperm (pulp).

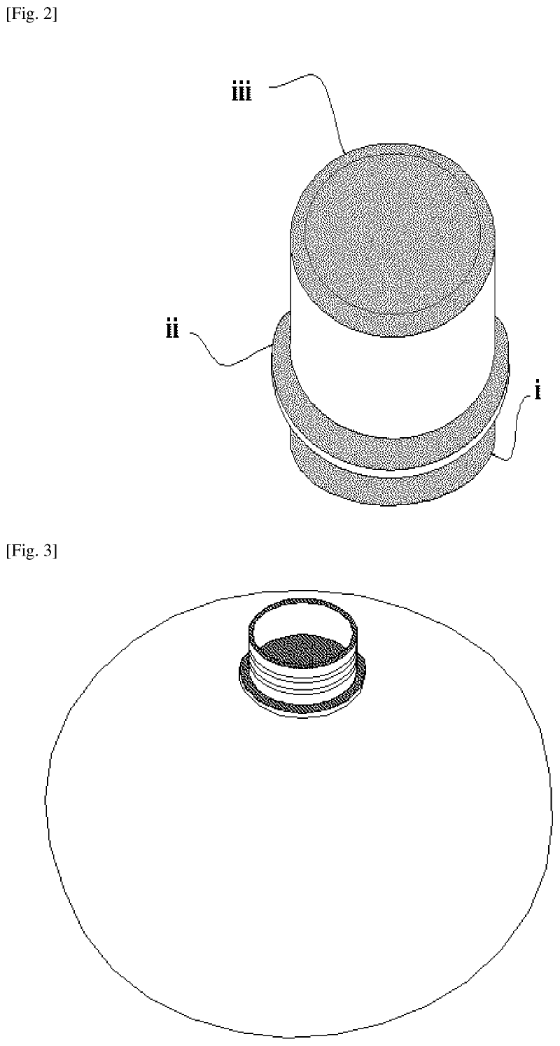

11) Application of food grade adhesive to the fastener area of the cap, consisting of: a) the bottom face of the skirt and b) to the outer face of the crown flange (FIG. 2).

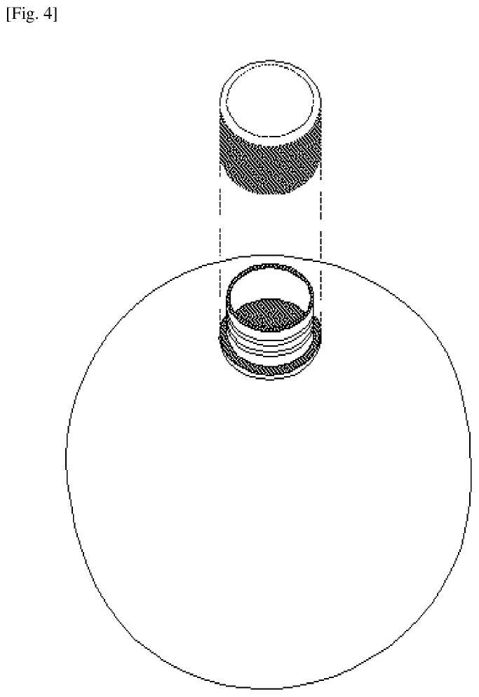

12) Placing the crown in the endocarp, matching the center of the circumference of the crown to the center of the circumference of the hole, which will allow the clamping area to adhere to the coconut, by aligning a) the inner face of the cutting wall with the outer face of the crown flange, and b) the outer face of the endocarp in the area surrounding the hole to the lower face of the skirt (FIGS. 3, 4 and 5).

### EXAMPLES

Next, we describe the best way to implement the method to drill coconut with integrated screw cap. It starts by shelling or “stripping” the coconut leaving the endocarp in view, it is polished to give a better visual presentation, then with a specialized cutting tool a circular cut of 26 mm in diameter is made at a speed of 1,600 rpm and a pressure of 800 N/mm², until reaching the pulp of the coconut taking care not to damage its integrity. Preferably, the cutting tool used will be a “snack” or a diamond cutting tip.

During the cut, ozone gas (O3) is injected to lift the generated micro particles and keep the cutting tool sanitized, once the cut has been made at sufficient depth, the cut endocarp is removed leaving the pulp in sight, Then a quick visual inspection of the endosperm conditions is carried out, since in some cases it may be rotten due to diseases of the fruit, this stage makes it possible to guarantee 100% product quality.

An important element for the proper functioning of the method that will be claimed below, is the use of a cap consisting of a threaded crown and a cap for which it can be made of two materials: plastics such as High Density Polyethylene (PAD), Low Density Polyethylene (PEBD), Ethylene

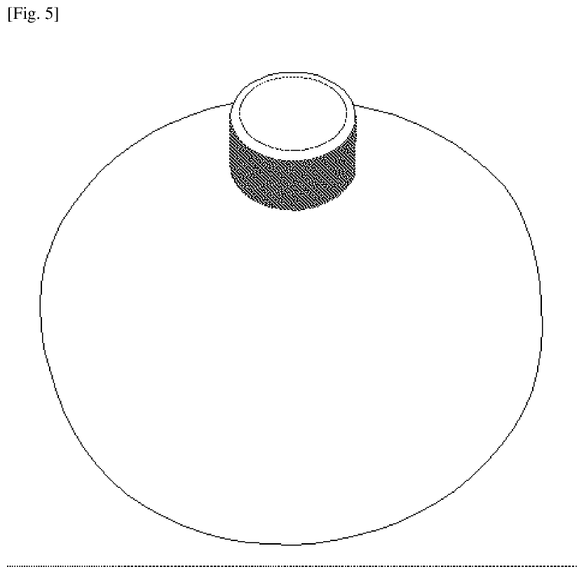

Polyterephthalate (PET), Vinyl Polychloride (PVC), Polypropylene (PP) and/or Polystyrene; and metallic like aluminum. Said cap should preferably have a diameter of 26 mm for both the threaded crown and the cap, facilitating its incorporation in a simple and practical way (FIG. 5).

The next stage consists of cleaning and sanitizing the exposed surface, a food grade adhesive is placed on the flange and the bottom face of the thread skirt which is placed in the cut, previously made, so that it has contact with the endocarp of the coconut, matching the center of the circumference of the crown with the center of the circumference of the hole, which will allow the clamping area to adhere to the coconut, finally proceed to seal with a plastic cover to keep the area fully aseptic.

The invention of the perforated coconut with integrated screw cap, as you can see is new (novel), because despite its practical and simple conformation it has no resemblance to any previous proposal or cited in this document.

### INDUSTRIAL APPLICATION

The present invention has industrial application in the food sector, particularly for obtaining coconut juice easily, without losing its nutritional properties and without using conservatives, this is achieved by drilling the endocarp (also known as bone) of the coconut and without touching the endosperm that serves as a natural barrier between the environment and the juice of the coconut, placing an open-easy screw cap, which facilitates its consumption quickly and safely exceeding the current state of the art used for the same purposes.

### LIST OF REFERENCE SIGNS

In the relative section of the figures, the description uses the following reference signs; iii) the screw cap; ii) the crown skirt and i) the crown tab.

### LIST OF CITED PATENTS

CA2902013, CN204916468, 1115606U, CA2844398, WO2016141431, WO2014146031, U.S. Pat. No. 8,709,519, WO201611536, US20150164130, US20150048110

1. The method for drilling coconut with integrated screw cap, characterized in that it allows in the same process to perform: a) coconut cleaning; b) a hole in the coconut endocarp; c) cleaning and sanitizing the cutting area; and d) the placement of a screw cap, in such a way that it allows storage and commercialization in the same way as it will reach the final consumer.

2. The method for drilling coconut with an integrated screw cap referred to in claim 1, wherein the step of cleaning the coconut consists in removing the exocarp and mesocarp (external and internal face of the bast) from the coconut to subsequently polish the endocarp eliminating excess fibers (husk).

3. The method for drilling coconut with integrated screw cap referred to in claim 2, wherein once the endocarp is cleaned and polished, coconuts between 8 and 10 months of maturity are selected, discarding those that present depressions in the circumference or that present collapses in its structure.

4. The method for drilling coconut with integrated screw cap referred to in claim 2, wherein once the coconut is selected, roughing of irregular bumps on the surface of the endocarp is performed in order to improve its aesthetic appearance and functionality derived from the balance of its structure.

5. The method for drilling coconut with integrated screw cap referred to in claim 1, wherein the step of making a hole in the coconut endocarp consists in identifying the most viable face for cutting, preferably using the flattest side of the coconut, which is positioned with said face facing the cutting tool.

6. The method for drilling coconut with integrated screw cap referred to in claim 5, wherein the position of the cutting tool will be in an axis perpendicular to said selected face of the coconut, so centered with the circumference of the coconut.

7. The method for drilling coconut with integrated screw cap referred to in claim 5, wherein once the coconut is placed with the selected face in the referred position, a circular cut is made in the endocarp with a tool of specialized cut within a certain variety. The resulting hole should be deep enough to reach the endosperm of the coconut.

8. The method for drilling coconut with integrated screw cap referred to in claim 7, wherein the cutting should be performed at a speed of 1,700 rpm and a pressure of 800 N/mm² and will result in a hole between 06 and 30 millimeters in diameter.

9. The method for drilling coconut with integrated screw cap referred to in claim 7, wherein once the hole is made, the cutting tool is removed, which removes the cut portion of the endocarp leaving the endosperm exposed.

10. The method for drilling coconut with integrated screw cap referred to in claim 1, wherein the cleaning and sanitizing stage of the cutting area begins with the injection of ozone gas (O3) at the time of cutting the endocarp with two objectives: a) generate a current that raises the micro particles that result from the cutting stage; and b) keep the cutting tool sanitized.

11. The method for drilling coconut with an integrated screw cap referred to in claim 1, wherein simultaneously an aspiration of the micro particles resulting from the endocarp cutting stage is performed, thereby avoiding: a) its accumulation in the cutting stage, either seated on the surface of both the coconut and at the station where the process is implemented; b) air circulation of the area surrounding the workstation; and c) the cross contamination of possible spores housed in the pores of the endocarp, which would otherwise contaminate the freshly drilled coconut, the workstation and the other coconuts that are undergoing the present process or that are stored nearby.

12. The method for drilling coconut with integrated screw cap referred to in claim 1, wherein once the coconut endosperm has been exposed, a gel with bactericidal spray-drying properties is applied on the exposed surface.

13. The method for drilling coconut with integrated screw cap referred to in claim 1, wherein the step of opening the easy-open cap begins with the application of food grade adhesive to the area of fastening the cap, consisting of: a) the underside of the skirt and b) to the outer face of the crown flange (FIG. 2).

14. The method for drilling coconut with integrated screw cap referred to in claim 13, wherein once the adhesive is applied, the crown of the cap is placed in the endocarp surrounding the orifice made, matching the center of the circumference of the same with the center of the crown of the cap, which will allow the clamping area to adhere to the coconut, by aligning a) the inner face of the cutting wall with the outer face of the crown flange, and b) the outer face of the endocarp in the area surrounding the hole to the bottom of the skirt.

15. The method for drilling coconut with an integrated screw cap referred to in claim 14, wherein once the crown of the cap is attached it joins the screw cap to prevent contamination of the endosperm and coconut juice.
